(19) United States
(12) Patent Application Publication
(10) Pub. No.: US 2019/0193570 A1
(43) Pub. Date: Jun. 27, 2019

(54) BRAKE CONTROL DEVICE

(71) Applicant: HONDA MOTOR CO., LTD., Tokyo (JP)

(72) Inventors: Junpei OKUMURA, Wako-shi (JP); Ryohei KONNO, Wako-shi (JP)

(21) Appl. No.: 16/215,772

(22) Filed: Dec. 11, 2018

(30) Foreign Application Priority Data
Dec. 22, 2017 (JP) 2017246625

(51) Int. Cl. B60L 7/26; B60T 13/58

(52) U.S. Cl. CPC B60L 7/26; B60T 13/586

(57) ABSTRACT

Provided is a brake control device (25) for controlling a regenerative brake (9) and a friction brake (11) mounted on a vehicle (1). The brake control device includes a vehicle speed sensor (21), a target deceleration determining unit (32), a target brake torque determining unit (34), a target friction torque determining unit (35), a friction brake command unit (36), a target speed determining unit (37), a feedback computation unit (38) configured to determine a feedback value according to a deviation of the vehicle speed from the target vehicle speed, a regenerative torque determining unit (39), and a regenerative brake command unit (40).

### TECHNICAL FIELD

The present invention relates to a brake control device for controlling a brake force of a vehicle.

### BACKGROUND ART

A vehicle may be provided with both a friction brake and a regenerative brake, and such a vehicle is also provided with a brake control device for controlling the brake torques produced by the respective brakes. See JP2017-60343A, for instance. The brake control device disclosed in this patent document is configured to determine the target brake torque that is required to decelerate the vehicle according to a given deceleration request. Upon receiving a deceleration request, this brake control device activates the friction brake so as to produce the desired friction torque corresponding to the target brake torque, and any shortfall of the friction torque in achieving the target brake torque is supplemented by a regenerative torque produced by the regenerative brake. Typically, the regenerative brake has a higher response speed than the friction brake. The activation of the regenerative brake is substantially instantaneous, but the actuation of the friction brake inevitably involves a certain time delay because of the use of a hydraulic system or a mechanical system in the activation of the friction brake. By thus combining the regenerative brake and the friction brake, the target brake force can be achieved with a fast response.

In the field of automated driving, it is important to control the distance of the own vehicle to another vehicle traveling ahead. However, in such a conventional brake control device, since the deceleration process is carried out so as to coincide the actual deceleration with a target deceleration by feedback control, and no consideration is made regarding the relative speed between the own vehicle and the vehicle traveling ahead. Therefore, the distance and/or the relative speed between the own vehicle and the vehicle traveling ahead may become undesirable great or small.

### SUMMARY OF THE INVENTION

In view of such a problem of the prior art, a primary object of the present invention is to provide a vehicle control device for controlling a friction brake and a regenerative brake that can respond to a deceleration request with a fast response and can control the speed of the own vehicle relative to a vehicle traveling ahead of the own vehicle at the same time.

To achieve such an object, the present invention provides a brake control device (25) for controlling a regenerative brake (9) and a friction brake (11) mounted on a vehicle (1), comprising

a vehicle speed sensor (21) configured to detect a current vehicle speed of an own vehicle;

a target deceleration determining unit (32) configured to determine a target deceleration of the own vehicle according to a deceleration request supplied thereto;

a target brake torque determining unit (34) configured to determine a target brake torque that is required to achieve the target deceleration;

a target friction torque determining unit (35) configured to determine a prescribed target friction torque;

a friction brake command unit (36) configured to command the friction brake to produce the target friction torque;

a target speed determining unit (37) configured to determine a target vehicle speed as a value that changes with time according to the target deceleration;

a feedback control value computation unit (38) configured to determine a feedback control value according to a deviation of the current vehicle speed from the target vehicle speed;

a regenerative torque determining unit (39) configured to determine a target regenerative torque according to the feedback value; and

a regenerative brake command unit (40) configured to command the regenerative brake to produce the target regenerative brake.

Thereby, the deceleration of the own vehicle in response to the deceleration request can be performed with a quick response by using the regenerative brake. Furthermore, because the regenerative torque is determined according to the feedback control of the deviation of the vehicle speed of the own vehicle from the target vehicle speed, the deviation of the vehicle speed of the own vehicle from the target speed can be quickly reduced, and no such deviation persists or, in other words, no steady state error remains in the vehicle speed when the deceleration process is completed.

Preferably, the target friction torque is selected as a value smaller than the target brake torque.

Thereby, the regenerative brake may be preferentially over the friction brake so that the energy efficiency of the vehicle can be improved.

Preferably, the friction torque determining unit (35) is configured to determine the target friction torque as a fixed value immediately after the deceleration request is received, and the regenerative torque determining unit is configured to determine the target regenerative torque such that a sum of the determined target regenerative torque and a current friction torque corresponds to the feedback value. The fixed value may be a maximum available regenerative torque.

Thereby, by using a simple control process, the regenerative brake and the friction brake can be jointly utilized to achieve a desired deceleration in an optimum fashion. When the fixed value is a maximum available regenerative torque, the brake torque available immediately after the deceleration request is received can be maximized.

The brake control device may further comprise a road condition determining unit (33) configured to determine a road condition of a road being traveled by the own vehicle, and the target brake torque determining unit is configured to determine the target brake torque according to the road condition.

Thereby, the desired deceleration can be accurately achieved without regard to the road condition such as the friction coefficient of the road and the inclination of the road.

According to a particularly preferred embodiment of the present invention, the regenerative torque determining unit is configured to determine the target regenerative torque to be substantially equal to the target brake torque when an available maximum regenerative torque is equal to or greater than the target brake torque, and to determine the target regenerative torque to be substantially equal to the maximum regenerative torque immediately after the deceleration request is received and to subsequently determine the target regenerative torque so that a sum of the target regenerative torque and a current friction torque is substantially equal to the target brake torque when the maximum regenerative torque is smaller than the target brake torque.

Thereby, without regard to the magnitude of the brake torque that is required to decelerate the vehicle, the regenerative brake and the friction brake can be jointly utilized to achieve a desired deceleration in an optimum fashion.

According to a certain aspect of the present invention, the deceleration request is determined according to the current vehicle speed of the own vehicle.

Thereby, a deceleration process can be adapted to the traveling speed of the vehicle in an optimum fashion.

According to another aspect of the present invention, the brake control device further comprises a relative speed detector (22) configured to detect a relative vehicle speed between the own vehicle and another vehicle traveling ahead of the own vehicle, and the deceleration request is determined according the relative vehicle speed.

Thereby, the deceleration process can be adapted to the operation of an adaptive cruise control.

Thus, according to the present invention, the deceleration of the own vehicle in response to the deceleration request can be performed with a quick response by using the regenerative brake. Furthermore, because the regenerative torque is determined according to the feedback control of the deviation of the vehicle speed of the own vehicle from the target vehicle speed, the deviation of the vehicle speed of the own vehicle from the target speed can be quickly reduced, and no such deviation persists or, in other words, no steady state error remains in the vehicle speed when the deceleration process is completed.

### BRIEF DESCRIPTION OF THE DRAWINGS

FIG. 1 is a block diagram of a vehicle incorporated with a brake control device according to an embodiment of the present invention;

FIG. 2 is a graph showing the relationship between the vehicle speed and the maximum regenerative torque of a regenerative brake;

FIG. 3 is a graph showing a typical time history of the friction torque (solid line) and the regenerative torque (broken line) that are produced in response to a deceleration request;

FIG. 4 is a block diagram of a deceleration processing unit of an adaptive cruise control unit;

FIG. 5 is a flowchart of a deceleration process;

FIG. 6 shows (A) a time history of the friction torque, the regenerative torque and the total brake torque in a deceleration process, and (B) a time history of the actual vehicle speed and the target vehicle speed according to the embodiment of the present invention;

FIG. 7 shows (A) a time history of the friction torque, the regenerative torque and the total brake torque in a deceleration process, and (B) a time history of the actual vehicle speed and the target vehicle speed according to the prior art; and

FIG. 8 shows (A) a time history of the friction torque, the regenerative torque and the total brake torque when a greater brake torque than is usual is required to achieve a prescribed deceleration, and (B) a time history of the friction torque, the regenerative torque and the total brake torque when a smaller brake torque than is usual is required to achieve a prescribed deceleration.

### DESCRIPTION OF THE PREFERRED EMBODIMENT(S)

A brake control device for a vehicle powered by an electric motor according to an embodiment of the present invention is described in the following with reference to the appended drawings.

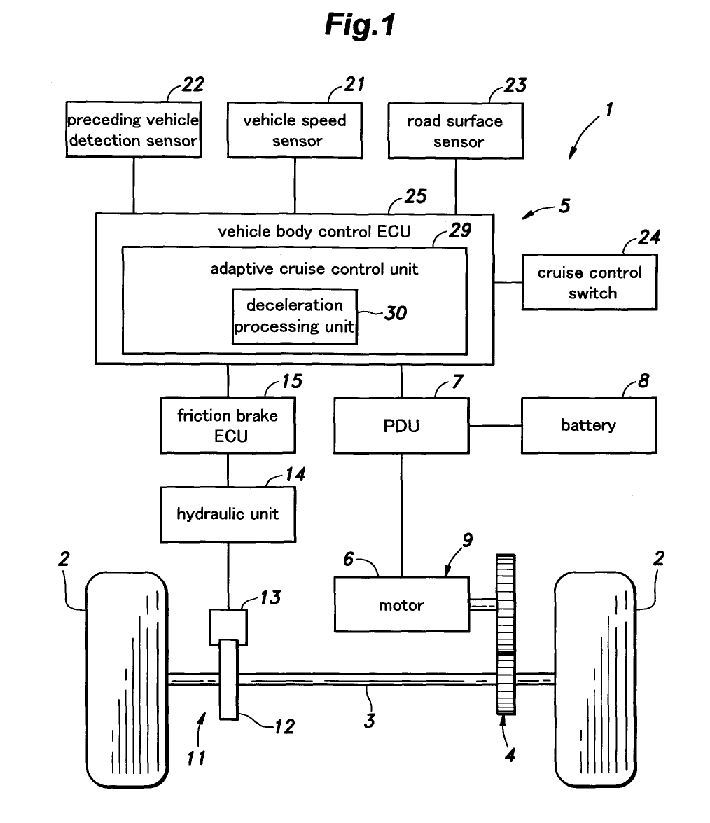

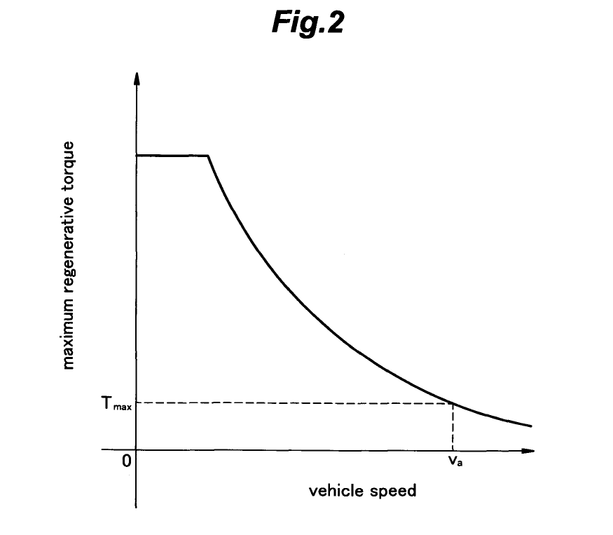

As shown in FIG. 1, a pair of drive wheels 2 of a vehicle 1 are provided at two ends of an axle 3, respectively, and the axle 3 is connected to an electric motor 6 mounted on a vehicle body 5 via a gear device 4. The motor 6 is connected to a battery 8 via a PDU 7 (power drive unit). The PDU 7 includes an inverter and a control circuit associated therewith, and in response to a drive command, supplies electric power from the battery 8 to the motor 6 to rotationally drive the motor 6. Also, when the PDU 7 receives a signal commanding a regenerative braking, the PDU 7 operates the motor 6 as a generator. The electric power generated by the motor 6 is stored in the battery 8. At this time, the motor 6 functions as a regenerative brake 9 that applies brake torque (regenerative torque) to the drive wheels 2. In response to a regenerative torque command, the PDU 7 controls the motor 6 in such a manner that the commanded regenerative torque is generated by the motor 6. The maximum value of the regenerative torque (maximum regenerative torque) generated by the motor 6 depends on the rotational speed of the drive wheels 2 or the vehicle speed of the vehicle 1. FIG. 2 shows the dependency of the maximum regenerative torque on the vehicle speed. It should be noted that the maximum regenerative torque that can be produced by the motor 6 progressively decreases as the rotational speed of the motor 6 increases, or the vehicle speed increases.

A friction brake 11 is provided on the axle 3. The friction brake 11 includes a disk 12 fixedly secured to the axle 3 and a brake pad 13 that is selectively brought into contact with the disk 12. The brake pad 13 is actuated by a hydraulic unit 14, and applies a brake force to the drive wheel 2 by frictionally engaging the disk 12. The hydraulic unit 14 may consist of a per se known hydraulic device that generates a hydraulic pressure by using an electric cylinder that is linearly actuated by a stepping motor via a ball screw mechanism. The electric cylinder is controlled by a friction brake ECU 15 which is mounted on the vehicle body 5. The friction brake ECU 15 is composed of a microcomputer, memory, a peripheral circuit, an input/output interface, various drivers, and the like. Upon receiving a friction torque command, the friction brake ECU 15 controls the hydraulic unit 14 in such a manner that the electric cylinder presses the brake pad 13 against the disk 12 with a pressure that is required to generate the commanded friction torque.

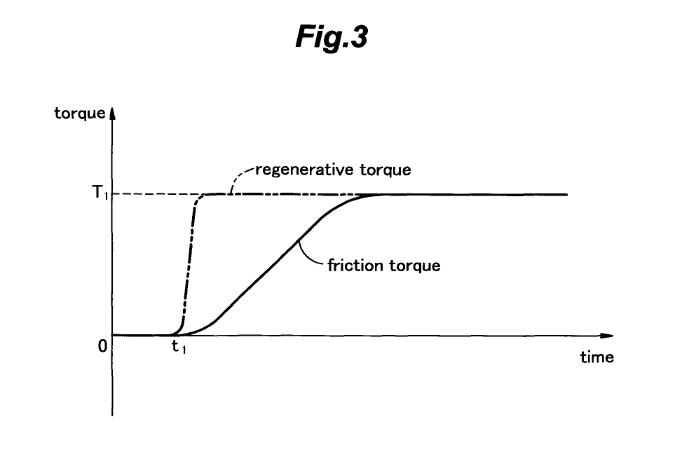

In FIG. 3, a solid line indicates the time history of the friction torque when the friction brake ECU 15 has received a command signal to generate a prescribed target friction torque T1 at time t=t1. As shown in FIG. 3, the friction torque progressively increases from time t=t1, and eventually reaches T1 after elapsing of a prescribe time period. As can be appreciated by a person skilled in the art, there is some time delay in the initiation of the friction torque generated by the friction brake 11 due to the time required for the hydraulic pressure to rise in the hydraulic system, and the time required for the brake pad 13 to be mechanically brought into contact with the disk 12 to generate the desired friction force. Thus, the commanded friction torque can be achieved only after elapsing of a certain time period following the reception of the friction torque command.

In FIG. 3, a double-dot chain-dot line indicates the time history of the regenerative torque when the PDU 7 has received a command signal to generate a prescribed target regenerative torque T1 at time t=t1. As opposed to the friction torque, the regenerative torque rises substantially instantaneously, and reaches the target value T1 in a very short time period.

As shown in FIG. 1, the vehicle 1 is provided with a vehicle speed sensor 21 for detecting the vehicle speed of the own vehicle. The vehicle speed sensor 21 may consist of a per se known speed sensor that detects the speed of the vehicle 1 from the rotational speed of the drive wheels 2 or the like. The vehicle speed sensor 21 may also consist of a speed sensor that detects the speed of the vehicle 1 by using a GPS signal, or that detects the speed of the vehicle 1 from the rotational speed of the motor 6.

The vehicle 1 is provided with a preceding vehicle detection sensor 22 in a front end part thereof. The preceding vehicle detection sensor 22 may consist of a per se known millimeter wave radar, microwave radar, etc., and is configured to detect the distance between the own vehicle and the preceding vehicle (vehicle traveling ahead) and the relative speed between the own vehicle and the preceding vehicle by radiating a radio wave onto the preceding vehicle and receiving the radio wave reflected by the preceding vehicle. The preceding vehicle detection sensor 22 provides the relative speed of the preceding vehicle with respect to the own vehicle as a negative value when the preceding vehicle is coming nearer to the own vehicle (when the vehicle speed of the own vehicle is higher than the vehicle speed of the preceding vehicle), and as a positive value when the preceding vehicle is moving away from the own vehicle (when the vehicle speed of the own vehicle is lower than the vehicle speed of the preceding vehicle).

The vehicle 1 is further provided with a road surface condition sensor 23. The road surface condition sensor 23 is configured to detect the state of the road surface on which the vehicle 1 is traveling, and may consist of a per se known sensor including a light emitting device and a light receiving device to determine the optical property of the road surface. When the road surface demonstrates a mirror surface property, it may be interpreted as a wet or a frozen road surface. When the road surface demonstrates a dispersive property, it may be interpreted as a dry surface.

The road surface condition sensor 23 may also consist of an image recognition system including a camera, and configured to extract from the captured images various characteristics indicative of moisture, snow and ice by means of a suitable image analysis.

The vehicle 1 is provided with a cruise control switch 24 for accepting a command to start and end a cruise control from the driver. The cruise control allows the vehicle 1 not only to travel at a commanded speed but also to automatically track a preceding vehicle so as to travel at the same speed as the preceding vehicle while keeping a suitable distance to the preceding vehicle.

The vehicle 1 is provided with a vehicle body control ECU 25. The vehicle speed sensor 21, the preceding vehicle detection sensor 22, the road surface condition sensor 23, the cruise control switch 24, the PDU 7, and the friction brake ECU 15 are connected to the vehicle body control ECU 25 via a communication line. The vehicle body control ECU 25 is composed of a microcomputer, memory, a peripheral circuit, an input/output interface, various drivers, and the like, and includes an adaptive cruise control unit 29 which is incorporated with a deceleration processing unit 30. Upon receiving an activation signal from the cruise control switch 24, the adaptive cruise control unit 29 controls the speed of the vehicle 1 according to the signals from the vehicle speed sensor 21, the preceding vehicle detection sensor 22 and the road surface condition sensor 23 via the PDU 7 and the friction brake ECU 15. For example, suppose that the vehicle speed of the own vehicle is controlled so as to keep the distance to the preceding vehicle to a prescribed value. If the preceding vehicle has started traveling slower and/or the inter-vehicle distance gets smaller than the prescribed value, the deceleration processing unit 30 executes a prescribed deceleration process for decelerating the vehicle in an appropriate manner.

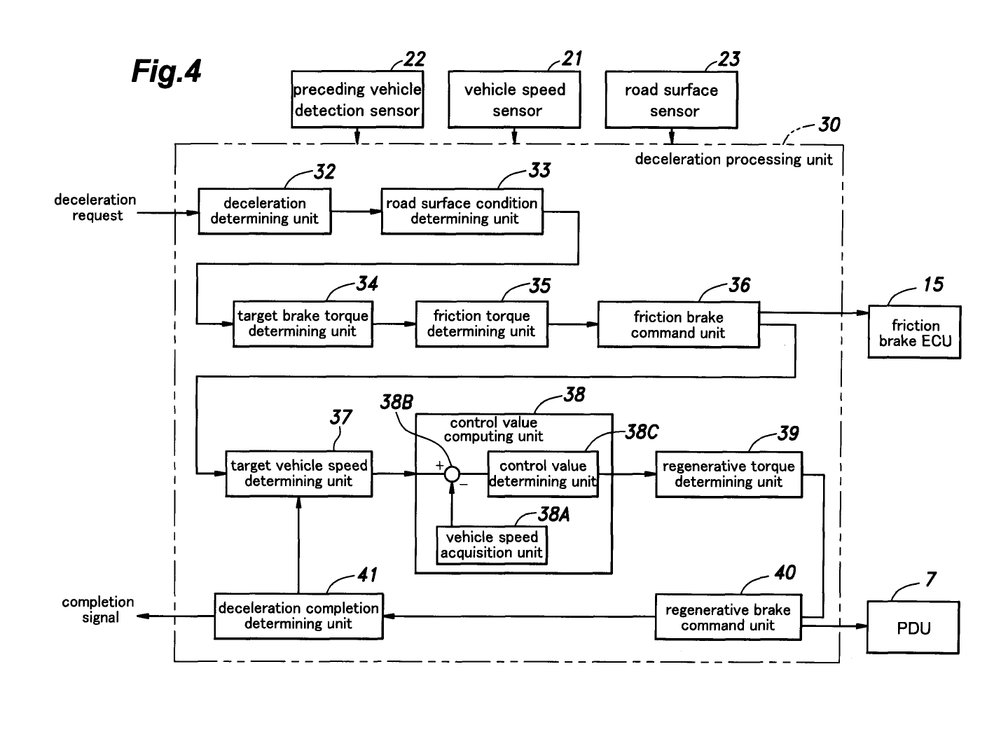

As shown in FIG. 4, the deceleration processing unit 30 includes a deceleration determining unit 32, a road surface condition determining unit 33, a target brake torque determining unit 34, a friction torque determining unit 35, a friction brake command unit 36, a target vehicle speed determining unit 37, a control value computing unit 38, a regenerative torque determining unit 39, a regenerative brake command unit 40, and a deceleration completion determining unit 41.

When a deceleration request is received from the adaptive cruise control unit 29, the deceleration determining unit 32 stores the time at which the deceleration request was made in the memory as a start time. Also, the own vehicle speed is acquired from the vehicle speed sensor 21, and the vehicle speed is stored as an initial vehicle speed in the memory. The deceleration determining unit 32 then acquires the inter-vehicle distance and the speed of the preceding vehicle relative to the own vehicle by the preceding vehicle detection sensor 22, and determines the target relative speed (which is zero when the own vehicle is to follow the preceding vehicle) and the target deceleration of the own vehicle that are to be achieved by the deceleration process by looking up a prescribed map stored in the memory. The deceleration determining unit 32 stores the target relative speed and the target deceleration in the memory, and forwards a signal indicating the completion of the determination of the target deceleration to the road surface condition determining unit 33 upon completion of the determination of the target deceleration.

Upon receiving the signal indicating the completion of the determination of the target deceleration from the deceleration determining unit 32, the road surface condition determining unit 33 acquires a signal indicating the road surface condition from the road surface condition sensor 23. The road surface condition determining unit 33 then calculates a friction coefficient between the vehicle 1 and the road surface according to the acquired signal by looking up a prescribed map stored in the memory. The calculated friction coefficient is forwarded to the target brake torque determining unit 34.

Upon receiving the friction coefficient from the road surface condition determining unit 33, the target brake torque determining unit 34 determines a target brake torque required for realizing the target deceleration according to the calculated friction coefficient by using a prescribed formula or by looking up a prescribed map. The target brake torque corresponds to the total torque produced jointly by the friction brake 11 and the regenerative brake 9 in order to realize the target deceleration. The formula and the map are configured to produce a greater value for the target brake torque as the friction coefficient decreases. Once the determination of the target brake torque is completed, the target brake torque is forwarded to the friction torque determining unit 35.

Upon receiving the target brake torque from the target brake torque determining unit 34, the friction torque determining unit 35 determines the available maximum regenerative torque at the initial vehicle speed by looking up a prescribed map stored in the memory and providing a relationship between the vehicle speed and the available maximum regenerative torque (FIG. 2). The friction torque determining unit 35 then determines the target friction torque by subtracting the maximum regenerative torque from the target brake torque. When the target brake torque is smaller than the maximum regenerative torque, the target friction torque is set to zero. Once the target brake torque determining unit 34 has determined the target friction torque, the determined target friction torque is forwarded to the friction brake command unit 36.

Upon receiving the target friction torque from the friction torque determining unit 35, the friction brake command unit 36 commands the friction brake ECU 15 to generate the target friction torque. Following this command, a signal indicating the start of the control of the friction brake 11 is forwarded to the target vehicle speed determining unit 37.

Once the signal indicating the start of the control of the friction brake 11 is received from the friction brake command unit 36 or the signal from the deceleration completion determining unit 41 is received from the friction brake command unit 36, the target vehicle speed determining unit 37 determines the target vehicle speed at this time according to the initial vehicle speed, the target acceleration and the start time. If the initial vehicle speed is v (m/s), the target deceleration is a (m/s²), the start time is t_{A} (s), and the input time is t_{B} (s), the target vehicle speed is then given by v−a (t_{B}−t_{A}) (m/s). Following this computation, the target vehicle speed determining unit 37 forwards the target vehicle speed to the control value computing unit 38.

When the target vehicle speed is received from the target vehicle speed determining unit 37, the control value computing unit 38 determines a feedback control value (control input) that is required to cause the vehicle speed to coincide with the target vehicle speed by controlling the regenerative torque, and forwards the determined feedback control value to the regenerative torque determining unit 39. More specifically, the control value computing unit 38 includes a vehicle speed acquisition unit 38A, a speed deviation computing unit 38B, and a control value determining unit 38C. The vehicle speed acquisition unit 38A acquires the vehicle speed (actual vehicle speed) of the vehicle 1 from the vehicle speed sensor 21, and forwards the acquired vehicle speed to the speed deviation computing unit 38B. The speed deviation computing unit 38B receives the target vehicle speed and the actual vehicle speed received from the vehicle speed acquisition unit 38A, and computes a deviation between the target vehicle speed and the actual vehicle speed. The computed deviation is forwarded to the control value determining unit 38C. The control value determining unit 38C determines and outputs a feedback control value based on the received deviation. The control value determining unit 38C may also determine the feedback control value according to any combination of the deviation of the actual vehicle speed from the target vehicle speed, the integral value of the deviation and the differential value of the deviation (PID), or according to the product of a certain coefficient and the deviation.

Upon receiving the feedback control value determined by the control value computing unit 38, the regenerative torque determining unit 39 determines the target regenerative torque that is to be produced by the regenerative brake 9. More specifically, the regenerative torque determining unit 39 acquires from the PDU 7 the actual regenerative torque produced by the regenerative brake 9, and adds the feedback control value to the actual regenerative torque to determine the target regenerative torque. Upon determining the target regenerative torque, the regenerative torque determining unit 39 forwards the determined target regenerative torque to the regenerative brake command unit 40.

The regenerative brake command unit 40 forwards a command to the PDU 7 to generate the target regenerative torque from the regenerative brake 9. Upon completion of the command, the regenerative brake command unit 40 forwards a signal indicating that the command has been completed to the deceleration completion determining unit 41.

When the command completion signal is received from the regenerative brake command unit 40, the deceleration completion determining unit 41 acquires the speed of the preceding vehicle relative to the own vehicle from the preceding vehicle detection sensor 22, and compares the relative speed with the target relative speed. When the relative speed is smaller than the target relative speed (deceleration is insufficient), the instruction to continue deceleration is forwarded to the control value computing unit 38. When the relative speed is greater than the target relative speed (deceleration is sufficient), the completion signal is forwarded to the adaptive cruise control unit 29.

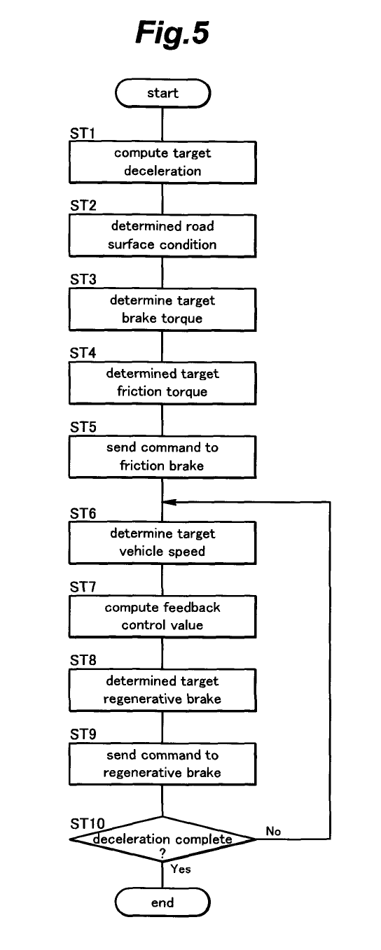

The mode of operation of the deceleration processing unit 30 is described in the following with reference to the flowchart shown in FIG. 5.

The deceleration determining unit 32 stores the time (start time) at which the deceleration request was received in the memory. The deceleration determining unit 32 also stores the own vehicle speed acquired by the vehicle speed sensor 21 at the start time as the initial vehicle speed in the memory. Further, based on the initial vehicle speed, the speed of the preceding vehicle relative to the own vehicle, and the inter-vehicle distance, the target deceleration and the target relative speed that is to be reached by the deceleration process are determined from the prescribed map stored in the memory, and are stored in the memory (step ST1). The road surface condition determining unit 33 then determines the friction coefficient between the road surface and the vehicle 1 (step ST2), and the target brake torque determining unit 34 computes the target brake torque that is required to achieve the target deceleration according to the target deceleration and the friction coefficient (step ST3).

Thereafter, the friction torque determining unit 35 computes the maximum regenerative torque that can be produced from the regenerative brake 9 based on the initial vehicle speed, subtracts the maximum regenerative torque from the target brake torque, and computes the target friction torque (step ST4). Thereafter, the friction brake command unit 36 sends a command to the PDU 7 to produce the target friction torque corresponding to the difference between the target brake torque and the maximum regenerative torque (step ST5). The friction brake 11 is then driven so as to produce the commanded friction torque.

The target vehicle speed is then determined by the target vehicle speed determining unit 37 (step ST6), and the control value computing unit 38 determines the feedback control value so that the deviation between the actual vehicle speed and the target vehicle speed is reduced to zero (step ST7). Based on the feedback control value, the regenerative torque determining unit 39 determines the target regenerative torque to be produced by the regenerative brake 9 (step ST8), and the regenerative brake command unit 40 sends a command to the PDU 7 to produce the target regenerative torque (step ST9). Upon receiving the command, the PDU 7 controls the regenerative brake to produce the commanded target regenerative torque. Upon completion of the command, the deceleration completion determining unit 41 determines that the speed of the preceding vehicle relative to the own vehicle has reached the target relative speed (step ST10). If it is determined in step ST10 that the relative speed has not reached the target relative speed, or in other words, that the deceleration is insufficient, and the speed of the preceding vehicle relative to the own vehicle is lower than the target relative speed, the process flow returns to step ST6. If the speed of the preceding vehicle relative to the own vehicle has reached the target relative speed, or if the vehicle has sufficiently decelerated, the deceleration process is ended.

The mode of operation of the vehicle body control ECU 25 is described in the following. When the target brake torque is smaller than the maximum regenerative torque, the target friction torque becomes zero. Therefore, the friction brake 11 is not driven. Since the response of the regenerative brake 9 is so fast that the time change of the vehicle speed becomes substantially equal to the time change of the target vehicle speed based on the target deceleration.

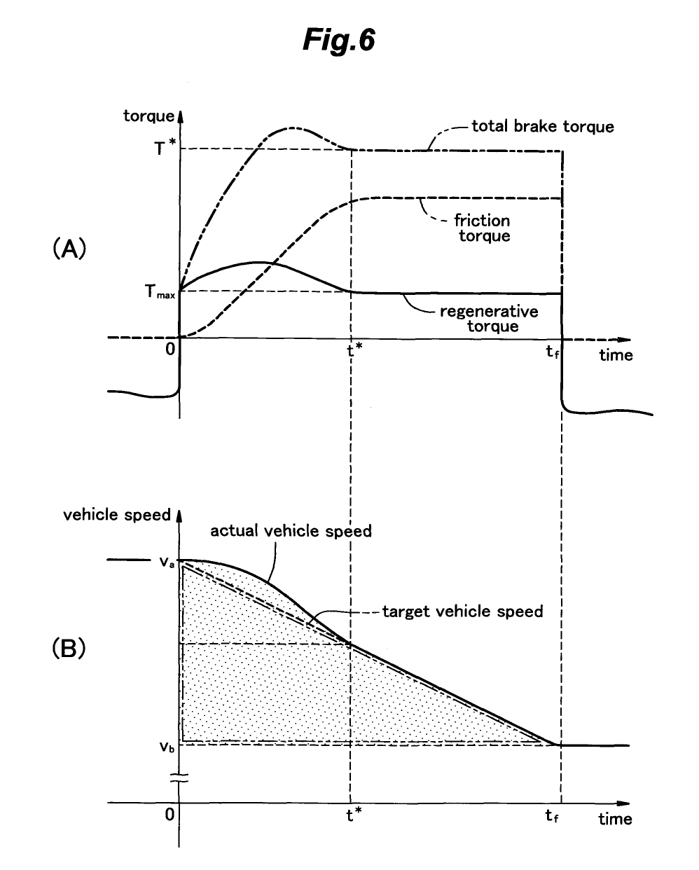

When the target brake torque is greater than the maximum regenerative torque, the friction brake 11 is required to be driven. In FIG. 6, (A) shows the time history of the friction torque (broken line), the regenerative torque (solid line), and the sum of the friction torque and regenerative torque (two-dot chain dot line), and (B) shows the time history of the actual vehicle speed (solid line) and the target vehicle speed (broken line). It is assumed that the target brake torque T* is greater than the maximum regenerative torque Tmax. In FIG. 6, a deceleration request is made at time t=0, and the corresponding deceleration process is completed at time t=t_{f}. The initial vehicle speed is vₐ, and the target relative vehicle speed is zero. Further, in FIG. 6, it is assumed that the vehicle speed vb of the preceding vehicle is constant.

As shown in FIGS. 3 and 6 (A), it requires a certain amount of time for the friction brake 11 to produce the target friction torque. Therefore, the friction brake 11 is unable to provide a sufficient brake torque immediately after the reception of a deceleration request. Therefore, as shown in FIG. 6 (B), the actual vehicle speed initially becomes higher than the target vehicle speed. As shown in FIG. 6 (A), the regenerative brake 9 produces the maximum regenerative torque Tmax for the given initial vehicle speed immediately after receiving the deceleration request so as to make up for the shortfall. As the actual vehicle speed decreases with the lapse of time, the maximum regenerative torque increases (see FIG. 2) while the friction torque also increases progressively. Eventually, the friction torque reaches the target friction torque (t=t*). Once this state is reached, the regenerative torque is controlled such that the actual vehicle speed is caused to coincide with the target vehicle speed. Thus, the friction brake 11 and the regenerative brake 9 jointly decelerate the vehicle 1 in a highly responsive manner.

In particular, the regenerative brake is controlled via a feedback control of the vehicle speed so as to follow the target vehicle speed which is scheduled over a prescribed time period. Therefore, the actual vehicle speed quickly converges to the target vehicle speed, and no deviation of the actual vehicle speed from the target speed remains. The regenerative torque may be required to be increased or decreased depending on the deviation of the actual vehicle speed from the target speed. Such regenerative torque is available because the vehicle speed has decreased, and this increases the available maximum regenerative torque. As a result, following the deceleration process, the own vehicle follows the vehicle traveling ahead at the same speed so that the inter-vehicle distance is prevented from becoming excessively great or small as opposed to the conventional arrangement.

Even with the brake control device of the illustrated embodiment, a small amount of steady state error in the inter-vehicle distance may remain. However, by using an additional control process, the inter-vehicle distance may be kept within an acceptable range. As can be appreciated by a person skilled in the art, such a control process does not require a fast response.

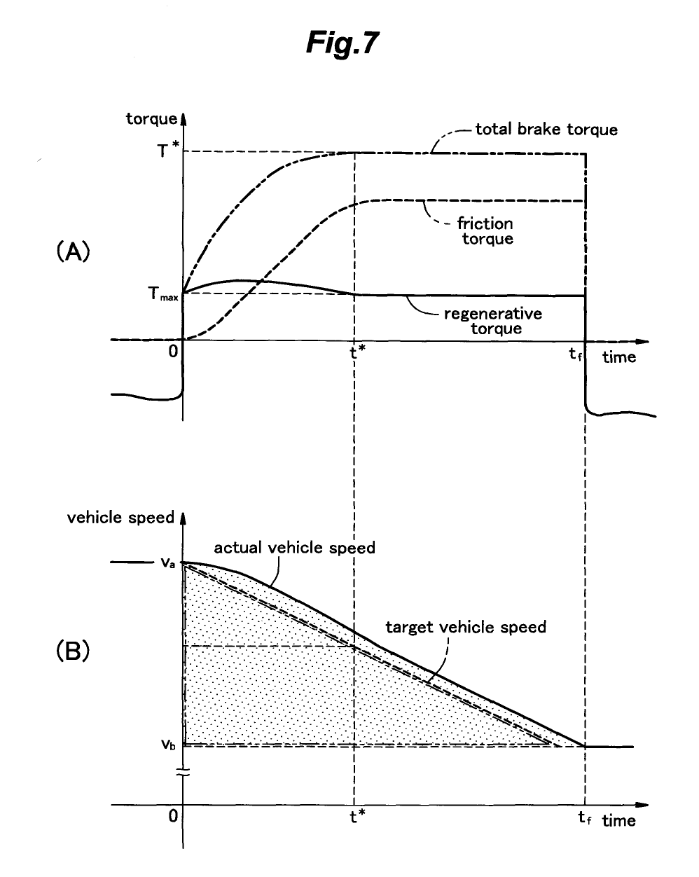

FIG. 7 is a diagram similar to that of FIG. 6 illustrating a hypothetical operation of a brake control device according to the prior art. In this case also, the maximum regenerative torque is produced as soon as a deceleration request is received, and the friction brake is actuated so as to fill the shortfall of the brake torque provided by the regenerative brake. The total brake torque is controlled by a feedback control so as to minimize the deviation between the target deceleration and the actual deceleration (or the total brake torque). This deceleration process is maintained for a time period that is required to decelerate the vehicle to from the initial vehicle speed vₐ to the target vehicle speed v_{b}. Since the feedback process is performed in regard to the deceleration of the vehicle, if the deceleration is constant, the vehicle speed decreases linearly, and eventually reaches the target vehicle speed v_{b}. Since the vehicle speed is not controlled during the deceleration process, the duration of the deceleration required to achieve the desired reduction in the traveling speed is indeterminate. As a result, the distance between the own vehicle and the vehicle traveling ahead cannot be controlled with any accuracy. Alternatively, if the time duration of the deceleration process is determined at the start of the deceleration process, the vehicle speed of the own vehicle at the end of the deceleration process may not coincide with the target vehicle speed v_{b}. In such a case also, the distance between the own vehicle and the vehicle traveling ahead cannot be controlled with any accuracy.

As shown in FIG. 6 and FIG. 7, the vehicle 1 can be decelerated with a fast response owing to the full utilization of the regenerative torque which can be built up in a very short time, and the necessary brake torque can be achieved by jointly utilizing the friction torque. However, in the case shown in FIG. 7, the deviation between the vehicle speed of the own vehicle and the vehicle speed of the vehicle traveling ahead may become undesirably great or small upon completion of the deceleration process. On the other hand, in the case shown in FIG. 6, the deviation between the vehicle speed of the own vehicle and the vehicle speed of the vehicle traveling ahead may can be minimized. The integral value of the deviation between the vehicle speed of the own vehicle and the vehicle speed of the vehicle traveling ahead corresponds to the change in the distance between the own vehicle and the vehicle traveling ahead. Therefore, the present invention has a particular advantage when applied to applications where a plurality of vehicles are required to travel at the same speed such as an intelligent cruise control system and vehicle platooning.

In the illustrated embodiment, the available maximum regenerative torque is utilized in an early part of the deceleration process. This is advantageous because the electric power that is produced in the electric motor 6 as a result of the operation thereof as a result of regenerative braking can be used to charging the battery 8 so that the energy efficiency of the vehicle 1 can be improved. However, in a later part of the deceleration process, the regenerative torque may be substantially less than the available maximum regenerative torque. Because the regenerative torque may not be obtained as much as required when the battery 8 is fully charged, it is advantageous to use the friction torque to some extent in order to achieve the total brake torque.

If a proper measure is taken to allow the regenerative torque to be produced to the full extent without regard to the state of charge of the battery 8, it may be arranged in such a manner that the available maximum regenerative torque is fully utilized throughout the deceleration process.

The target brake torque that is required to decelerate the vehicle 1 may vary depending on various conditions such as the weight of the vehicle (that may vary depending the number of passengers and the weight of the cargo in the vehicle 1), the inclination of the road, and the friction coefficient of the road surface.

In this embodiment, the target brake torque determining unit 34 is configured to increase the target brake torque when the road surface is slippery, when the friction coefficient of the road surface is relatively low and/or when the weight of the vehicle 1 is greater than the usual value (because of a large number of passengers on board or a heavy cargo). By thus adapting the target brake torque to the road surface condition, an appropriate brake torque can be applied to the vehicle 1.

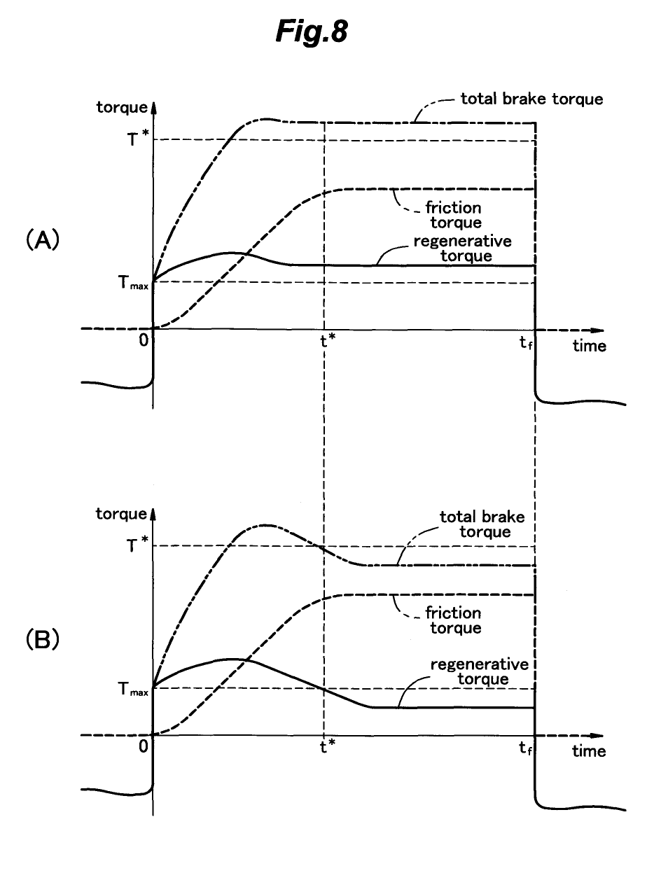

(A) in FIG. 8 shows a time history of torques of the present embodiment in the case where the total brake torque is required to be greater than usual owing to a low friction coefficient of the road surface and/or a downward incline of the road surface. (B) in FIG. 8 shows a time history of torques of the present embodiment in the case where the total brake torque is required to be smaller than usual owing to a high friction coefficient of the road surface and/or an upward incline of the road surface.

In the present embodiment, since the regenerative torque is feedback controlled so that the actual vehicle speed is caused to coincide with the target vehicle speed. According to the present embodiment, without regard to the weight of the vehicle, the magnitude of the friction coefficient and/or the inclination of the road surface, the brake torque is produced so as to cause the vehicle speed to coincide with the target vehicle speed (which typically decreases linearly with time). As a result, the deceleration will be appropriate, and the inter-vehicle distance is prevented from being reduced to an unacceptable small value. Even in the illustrated embodiment, by taking into account the weight of the vehicle, the magnitude of the friction coefficient, and/or the inclination of the road surface in determining the target brake torque, the control process can be performed in a favorable manner.

On other hand, according to the prior art, when the weight of the vehicle 1 is greater than the usual value, when the road surface is inclined downward or when the friction coefficient of the road surface is low, the target brake torque based on the calculation formula or the map may not allow the vehicle to decelerate in an appropriate manner because the brake torque is feedback controlled so as to minimize the deviation between the target brake torque and the sum of the regenerative brake and the friction brake. Therefore, it is essential to adjust the target brake torque according to the weight of the vehicle, the inclination of the road surface and/or the friction coefficient of the road surface.

The friction torque determining unit 35 may increase the target friction torque with a decrease in the friction coefficient as computed by the road surface condition determining unit 33. For instance, the friction torque determining unit 35 may determine the target friction torque according to a product of a coefficient that increases with a decrease in the friction coefficient and a difference between the target brake torque and the maximum regenerative torque. By thus increasing the magnitude of the friction torque when the target brake torque is greater than usual, the operation margin of the regenerative brake 9 can be increased so that a reliable operation of the brake control device can be enhanced. Similar arrangements may be made with regard to the weight of the vehicle and the inclination of the road surface.

Although the present invention has been described in terms of a specific embodiment, the present invention is not limited by the described embodiment, but can be modified and substituted in various ways without departing from the spirit of the present invention. For instance, in the above embodiment, the friction brake 11 consisted of a disk brake, but the present invention may also be applied to other types of brake systems such a drum brake or an electromagnetic brake. The vehicle may be also provided with two or more brake systems.

In the foregoing embodiment, the vehicle body control ECU 25 consisted of a single unit, but may consist of two ore mote units that are configured to cooperate with one another so to jointly constitute the cruise control device. In such a case, one of the units may be connected to the vehicle speed sensor 21 and the preceding vehicle detection sensor 22 so as to determine the target vehicle speed and the target deceleration, while another one of the units is connected to the friction brake ECU 15 and the PDU 7, and configured to determine the target regenerative torque and the target friction torque.

In the foregoing embodiment, the road surface condition sensor 23 was mounted on the vehicle 1, but it may also be a road surface condition sensor 23 provided on the road side, and configured to communicate with the vehicle body control ECU 25.

1. A brake control device for controlling a regenerative brake and a friction brake mounted on a vehicle, comprising
a vehicle speed sensor configured to detect a current vehicle speed of an own vehicle;
a target deceleration determining unit configured to determine a target deceleration of the own vehicle according to a deceleration request supplied thereto;
a target brake torque determining unit configured to determine a target brake torque that is required to achieve the target deceleration;
a target friction torque determining unit configured to determine a prescribed target friction torque;
a friction brake command unit configured to command the friction brake to produce the target friction torque;
a target speed determining unit configured to determine a target vehicle speed as a value that changes with time according to the target deceleration;
a feedback control value computation unit configured to determine a feedback control value according to a deviation of the current vehicle speed from the target vehicle speed;
a regenerative torque determining unit configured to determine a target regenerative torque according to the feedback value; and
a regenerative brake command unit configured to command the regenerative brake to produce the target regenerative brake.

2. The brake control device according to claim 1, wherein the target friction torque is selected as a value smaller than the target brake torque.

3. The brake control device according to claim 2, wherein the friction torque determining unit is configure to determine the target friction torque as a fixed value immediately after the deceleration request is received, and the regenerative torque determining unit is configured to determine the target regenerative torque such that a sum of the determined target regenerative torque and a current friction torque corresponds to the feedback value.

4. The brake control device according to claim 3, wherein the fixed value is a maximum available regenerative torque.

5. The brake control device according to claim 1, further comprising a road condition determining unit configured to determine a road condition of a road being traveled by the own vehicle, and the target brake torque determining unit is configured to determine the target brake torque according to the road condition.

6. The brake control device according to claim 5, wherein the road condition includes a friction coefficient of the road.

7. The brake control device according to claim 5, wherein the road condition includes an inclination of the road.

8. The brake control device according to claim 1, wherein the regenerative torque determining unit is configured to determine the target regenerative torque to be substantially equal to the target brake torque when an available maximum regenerative torque is equal to or greater than the target brake torque, and to determine the target regenerative torque to be substantially equal to the maximum regenerative torque immediately after the deceleration request is received and to subsequently determine the target regenerative torque so that a sum of the target regenerative torque and a current friction torque is substantially equal to the target brake torque when the maximum regenerative torque is smaller than the target brake torque.

9. The brake control device according to claim 1, wherein the deceleration request is determined according to a current vehicle speed of the own vehicle.

10. The brake control device according to claim 1, wherein the brake control device further comprises a relative speed detector configured to detect a relative vehicle speed between the own vehicle and another vehicle traveling ahead of the own vehicle, and the deceleration request is determined according the relative vehicle speed.
